(19) United States
(12) Patent Application Publication
(10) Pub. No.: US 2009/0160184 A1
(43) Pub. Date: Jun. 25, 2009

(54) End Connector For Flexible Pipe

(76) Inventor: Dang The VO, Houston, TX (US)

Correspondence Address: WONG, CABELLO, LUTSCH, RUTHERFORD & BRUCCULERI,;L.L.P., 20333 SH 249 6th Floor, HOUSTON, TX, 77070, US

(21) Appl. No.: 11/961,709

(22) Filed: Dec. 20, 2007

(51) Int. Cl. F16L 33/00

(52) U.S. Cl. 285/249

(57) ABSTRACT

An end connector for a flexible pipe positions onto an end of the flexible pipe. An insert having inner and outer conical surfaces positions in the connector's housing. To mechanically grip the pipe's inner layers, an outer sleeve positions in the housing against the first layer, and an outer nut threads onto the outer sleeve and compresses the first layer against the insert's outer surface. Also, an inner sleeve positions in the housing against a second layer, and an inner nut threads onto the sleeve and compresses the second layer against the insert inner surface. A tubular sleeve can position within an internal bore of the pipe for support, and another conical sleeve can be engaged between the housing and the outside of the pipe. The connector's end can be flexible or rigid along the pipe, while a flange on the connector's other end can bolt to another component.

### BACKGROUND

Flexible pipe can be used for fluid transport. FIG. 1, for example, shows a flexible pipe 10 similar to that designed by Deepflex, Inc. of Houston, Tex. In general, the pipe 10 can have internal diameters of 2, 4, 6, 8 or even up to 16-inches. From inside to outside, the flexible pipe 10 has a number of layers, including a liner layer 11, pressure reinforcement layers 12, hoop reinforcement layers 13, a membrane 14, tensile reinforcement layers 15, and an external jacket 16, such as disclosed in U.S. Pat. Nos. 6,491,779 and 7,254,933 and used in deepsea operation such as disclosed in U.S. Pat. No. 7,073,978. The liner layer 11 is typically composed of extruded thermoplastic, such as HDPE, PA-11, PVDF and XLPE. The membrane 14 is made of extruded thermoplastic to seal against compressive loads from external seawater pressure, and the external jacket 16 is made of extruded thermoplastic to provide external protection to the pipe 10.

The reinforcement layers 12, 13, and 15 each have wraps helically wound about the pipe 10. These wraps are made of composite material bonded and stacked together to form composite tapes. The pressure layers 13 are wound for external pressure loads, and the hoop layers 13 are wound for compressive loads. Likewise, the tensile layers 15 are wound for tensile loads.

Because there is no steel within the flexible pipe to weld any connections, operators must use an end connector on the end of the flexible pipe 10 to make any needed connections. In FIG. 1, a prior art end connector 100 is shown in cross-section coupled to the end of flexible pipe 10. The end connector 100 has a flanged end 110, a housing 120, an internal cone 130, a retaining ring 140, and an internal sleeve 150. Components of the end connector 100 are primarily composed of steel for coupling to other equipment. Within the connector 100, however, resin inserted through ports 122/132 fills open areas of the connector 100 and pots the composite layers 12 and 15 into a conical resin wedge within the housing 120.

Assembling the end connector 100 on the flexible pipe 10 presents a number of difficulties. In particular, below ring 125 on the end of the connector 100 lies a smaller ring that requires high precision to fit on the outside diameter of the pipe 10. Typically, these components cannot be manufactured until the pipe 10 on which they will install is actually fabricated because the dimensions of the pipe 10 are not yet known. Moreover, these components make any variances in the flexible pipe 10 difficult to manage during assembly. In addition, filling the voids on either side of the internal cone 130 through the filling ports 122/132 can be challenging because assemblers must be careful to avoid producing air pockets in the filling resin, which could weaken the connection. Moreover, use of the resin itself can make it difficult to know the resulting strength of the end connector 100 on the flexible pipe 10 due to the variable properties of the resin in general and its resulting chemical bond with other components in the connector 100.

### SUMMARY

A flexible pipe end connector has a housing fitting onto an end of the flexible pipe. Within the housing, an insert having outer and inner conical surfaces separates at least two inner layers of the flexible pipe. Positioned on the outside of the insert in the housing, an outer sleeve engages against at least one first inner layer of the flexible pipe, and an outer threads onto the outer sleeve and compresses the first inner layer against the insert. Positioned on the inside of the insert, an inner sleeve engages against at least one second inner layer, and an inner nut threads onto the inner sleeve and compresses the second inner layer against the insert. Yet another sleeve can be used between the housing and the outside of the pipe to compress against the pipe. In addition, a cylindrical sleeve is preferably positioned within the internal bore of the flexible pipe.

### BRIEF DESCRIPTION OF THE DRAWINGS

FIG. 1 illustrates a cross-section of an end connector for a flexible pipe according to the prior art.

FIGS. 2A-2B illustrate cross-sectional views of an end connector for a flexible pipe according to certain teachings of the present disclosure.

FIG. 2C illustrates a perspective view of layers of the flexible pipe prepared for the disclosed end connector.

FIGS. 3A-3C illustrate cross-sectional, detailed, and perspective views of a stiffener body.

FIG. 4 illustrates a perspective view of another stiffener body.

FIGS. 5A-5B illustrate cross-sectional and perspective views of an adapter lock.

FIGS. 6A-6C illustrate cross-sectional and perspective views of a shell.

FIGS. 7A-7B illustrate cross-sectional and perspective views of an internal sleeve.

FIGS. 8A-8C illustrate perspective, cross-sectional, and detailed views of a stiffener sleeve.

FIGS. 9A-9C illustrate perspective, cross-sectional, and end views of an outer taper nut.

FIGS. 10A-10C illustrate perspective, cross-sectional, and detailed views of an outer taper sleeve.

FIG. 11 illustrates a cross-sectional view of a slopped insert.

FIGS. 12A-12C illustrate perspective, cross-sectional, and end views of an inner taper nut.

FIGS. 13A-13C illustrate perspective, cross-sectional, and detailed views of an inner taper sleeve.

FIGS. 14A-14B illustrate cross-sectional and perspective views of another end connector according to certain teachings of the present disclosure.

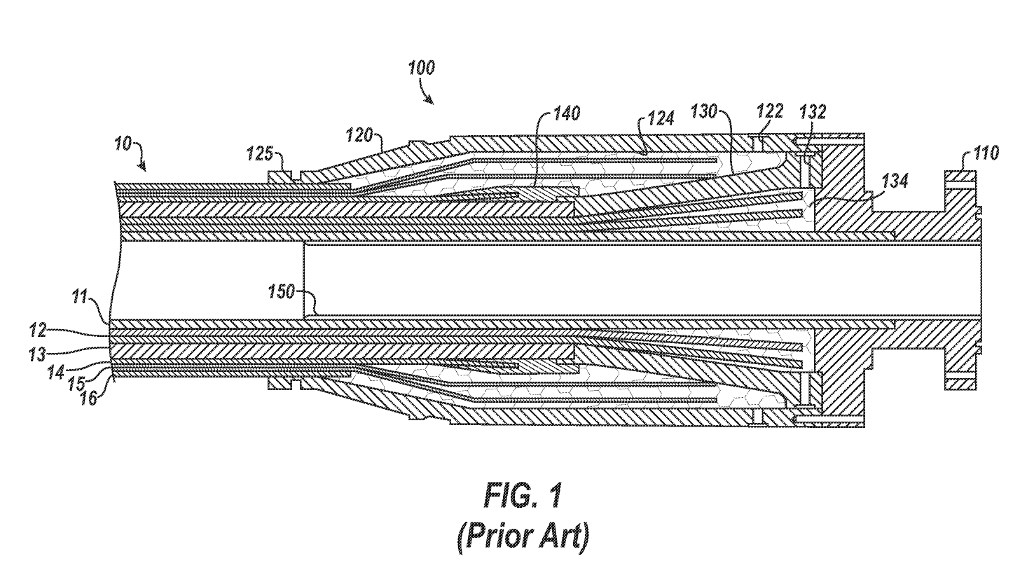

### DETAILED DESCRIPTION

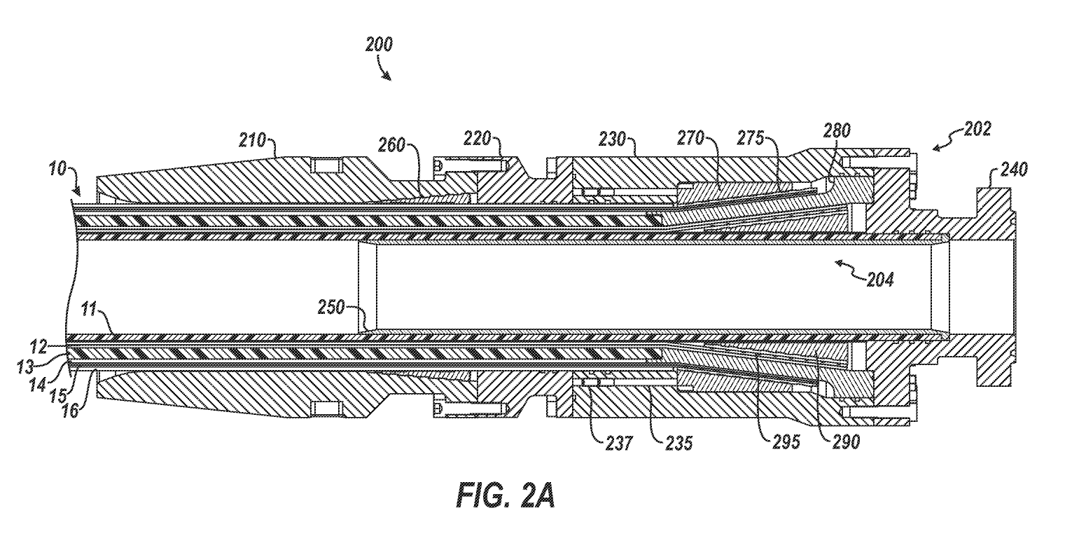

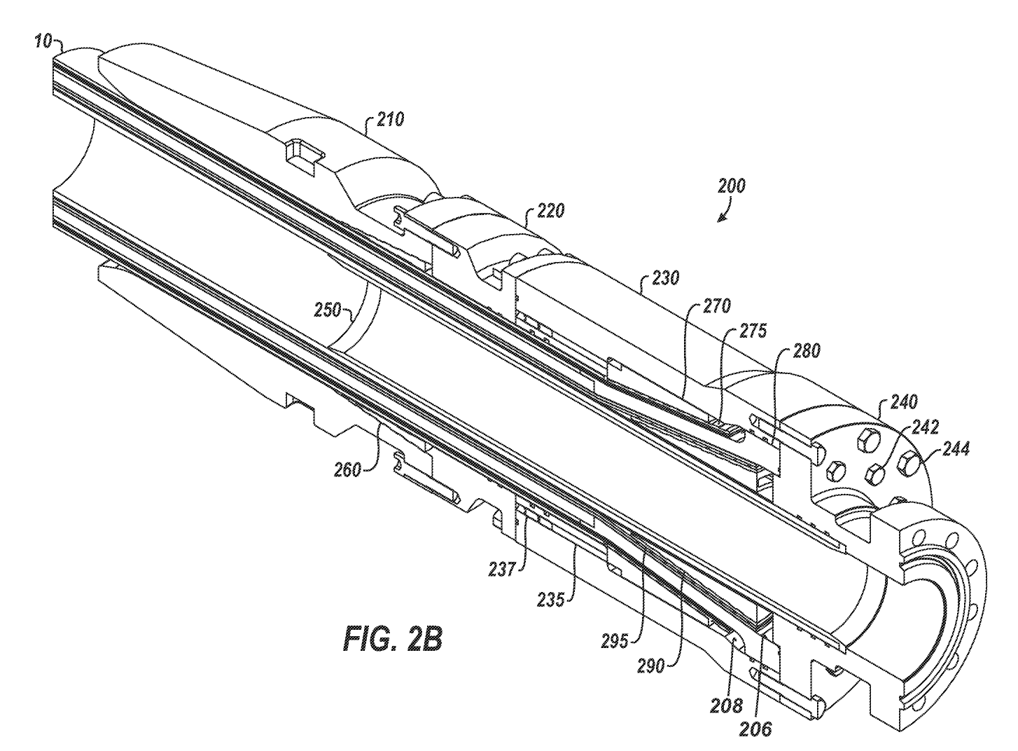

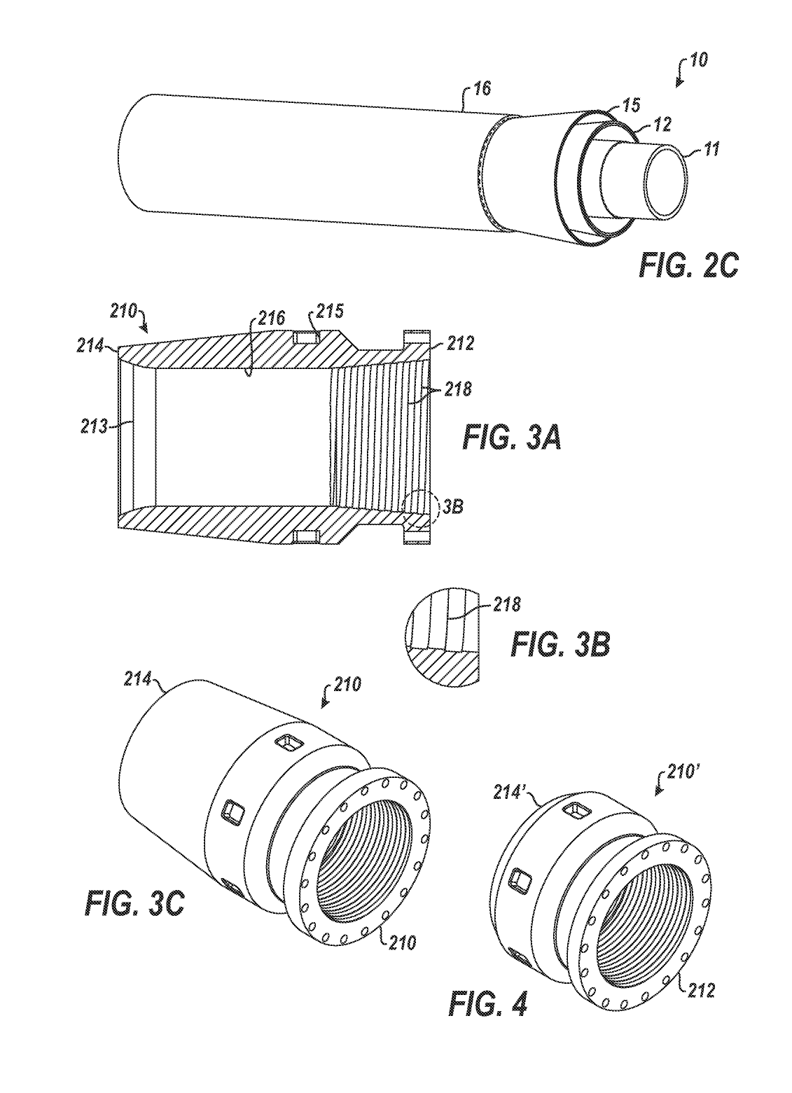

Referring to FIGS. 2A-2B, an end connector 200 according to certain teachings of the present disclosure is shown in cross-sectional views coupled to a flexible pipe 10. The pipe 10 has a plurality of layers 11-16 and can be similar to that designed by Deepflex, Inc. of Houston, Tex. and discussed previously. The end connector 200 couples to the end of the pipe 10 by mechanically gripping layers of the pipe 10 as opposed to potting layers in resin as currently used in prior art. In the embodiment shown, the end connector 200 is a riser assembly connector preferably used for a relatively shorter span of flexible pipe 10 such as used in a riser application or the like.

In particular, the end connector 200 has an external housing 202 fitting on the end of the pipe 10 and has mechanical locking or gripping devices 204 fitting within the housing 202 and engaging layers of the pipe 10. The external housing 202 includes a stiffener body 210, an adapter lock 220, a shell 230, and a flanged end 240, which all couple together to form the length of the end connector 200. Internally, the mechanical locking or gripping devices 204 include an internal sleeve 250, a stiffener sleeve 260, an outer taper nut 270 and sleeve 275, a slopped insert 280, and an inner taper nut 290 and sleeve 295, each of which engage one or more layers of the flexible pipe 10.

Briefly, the insert 280 positioned in the housing 202 has inner and outer surfaces that separate layers 12 and 15 of the pipe 10. An outer lock positioned in the housing 202 has an outer nut 270 and sleeve 275 that engage and compress layers 15 against the insert 180. Likewise, an inner lock positioned in the housing 202 has an inner nut 290 and sleeve 295 that engage and compress layers 12 against the insert 280. These components also fit against the pipe's other layers (e.g., 11, 13, 14, and 16). The internal sleeve 250 positions within the bore of the pipe 10, and the stiffener sleeve 260 positions between the housing 202 and the pipe's external jacket 16 and compresses against the pipe 10.

With an understanding of the end connector 200's components, detailed descriptions of each of the connector 200's components are discussed in conjunction with stages of assembling the end connector 200 on the end of the pipe 10.

Assembly Stage A

In assembling the end connector 200, the end of the flexible pipe 10 is prepared by trimming the layers 11-16 to allow components of the end connector 200 to fit on the prepared end. FIG. 2C shows how the pipe's layers 11-16 are prepared. The pipe's external jacket 16 is trimmed a predetermined distance from the extending inner layer 11 to at least approximately match the location of components to be positioned near the trimmed jacket 16. The pressure and tensile reinforcement layers 12 and 15 are likewise trimmed to a predetermined distance from the extending inner layer 11 as are those layers (13/14) not visible in FIG. 2C. As shown, the pressure and tensile reinforcement layers 12 and 15 will ultimately be flared out during later assembly to fit the various gripping components, as discussed below.

Assembly Stage B

With the pipe 10 prepared, the end of the pipe 10 positions vertically on a stand for easy installation of components by assemblers. The stiffener 210, stiffener sleeve 260, adapter lock 220, shell 230, and outer taper nut 270 and sleeve 275 slip onto the end of the pipe 10 in this order for assembly during later stages.

Assembly Stage C

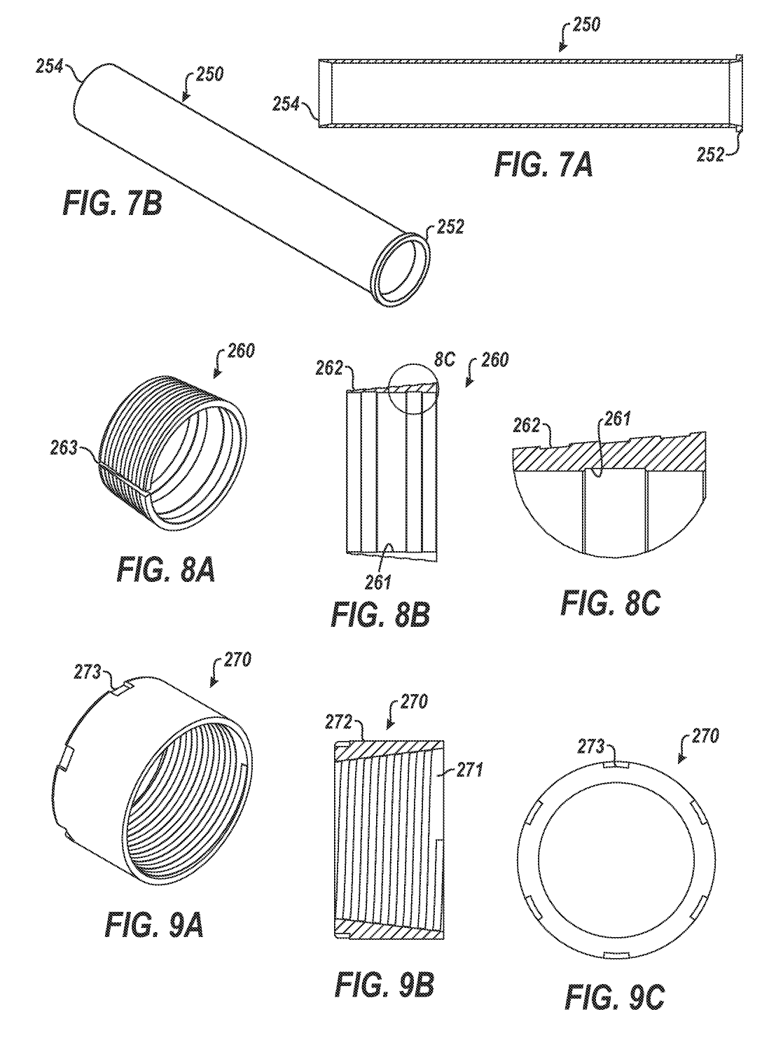

With components slipped on the pipe 10, the inner sleeve 250 positions within the internal diameter of the pipe's liner layer 11, which can help reinforce the end of the pipe 10 during assembly. As shown in FIGS. 7A-7B, the inner sleeve 250 has an elongated tubular shape. Inside edges of the sleeve 250 at both ends 252 and 254 are beveled to induce laminar flow through the sleeve 250 when used. In addition, the first end 252 has a capped edge that, as shown in FIGS. 2A-2B, engages the end of the pipe's inner layer 11 once the sleeve 250 is inserted. For illustrative purposes, the inner sleeve 250 can have a length of about 37.25-inches for a flexible pipe 10 having an internal diameter of about 6-inches and an outside diameter of about 10-inches.

Assembly Stage D

Next in assembly, assemblers flare out layers 12 and 15 as shown in FIG. 2C and then position the sloped insert 280 between the separated layers 12 and 15. As best shown in FIGS. 2A-2B, the insert 280's smaller end positions against the trimmed ends of layers 13 and 14. As shown in FIG. 11, the slopped insert 280 has a conical outer surface 282 and a conical inner surface 284. The larger diameter end 286 defines an outer cylindrical shelf 287 that fits against the inside of the shell (230; FIG. 2A) with a set of O-ring seals. In addition, the larger diameter end 286 has a number of threaded holes 285 to receive bolts connecting the insert 280 and the flanged end (240; FIG. 2A) together. The smaller diameter end 288 defines a cutaway 289 to fit against the terminated end of the membrane (13; FIG. 2A).

Assembly Stage E

With the insert 280 in position, the inner taper sleeve 295 inserts between the liner layer 11 and the flared reinforcement layers 12. Once inserted, the assemblers twist the inner taper nut 290 in between the sleeve 295 and the liner layer 11. As it is turned, the nut 290 threads onto the sleeve 295 and compresses the sleeve 295 and layers 12 against the inside surface of the insert 280 through the applied toque. The amount of torque and compression to be applied depends in part on the desired connection strength and the material used for the layers. Assemblers can then fill the annular void 206 at the end of the sleeve 295 and nut 290 with epoxy to the edge of the wide end of the insert 280. Assemblers position the flanged end 240 against the insert 280 and inner sleeve 250, enclosing the encased epoxy, sleeve 295, and nut 290 inside. Assemblers then bolt the flanged end 240 onto the insert 280 using a first set of bolts 242.

As one alternative, the taper nut 290 and sleeve 290 can be combined together as an integral component. Assemblers can wedge this integral component between the layers 11 and 12, position a larger washer over extended layer 11, and thread the washer's outer circumference to an internal thread on the insert 280. In this way, the integral wedge can compress the layers 12 against the insert, and the washer can hold the integral wedge and fill the void 206 (See FIG. 2A).

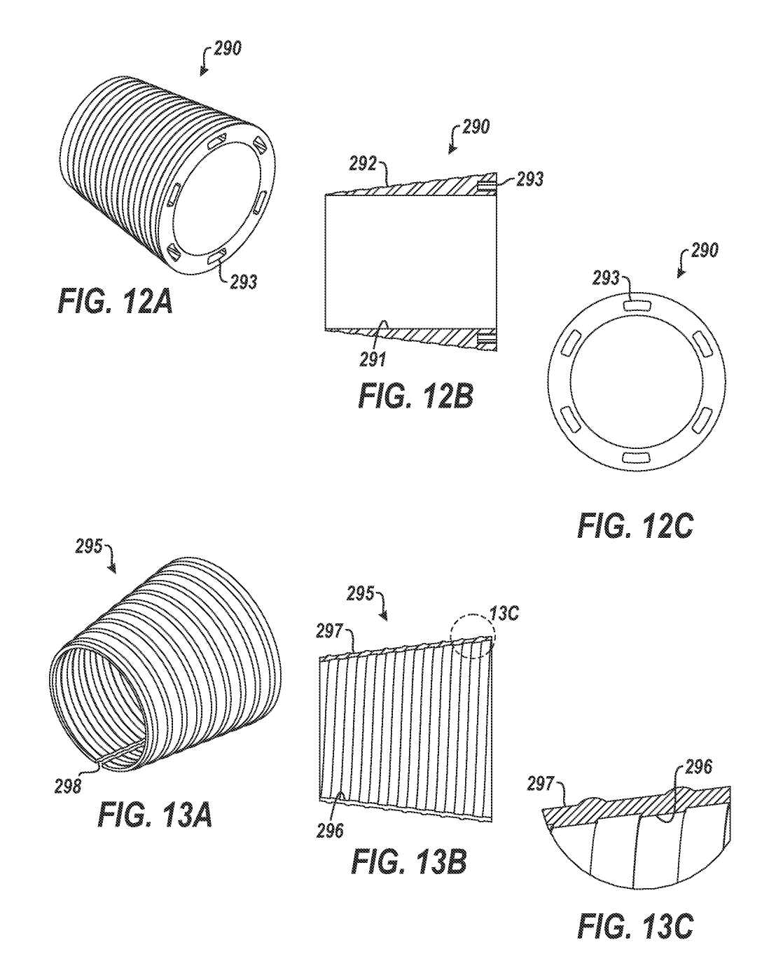

As shown in FIGS. 12A-12C, the inner taper nut 290 has a cylindrical inner surface 291 that is smooth and fits against the liner layer 11's outside surface. The nut 290 also has a conical outer surface 292 defining a left-handed thread for threading with the taper sleeve (295). The conical surface 292 in one embodiment may define an angle of about 7-degrees. However, the length and angle of the conical surface 292 of this nut and the other like components can be adjusted depending on the implementation and desired surface area for engaging the pipe's layers. The end of the nut 290 that fits against the flanged end 240 defines a plurality of notches 293 to allow a tool to rotate and torque the nut 290 when threading it into the taper sleeve (295).

As shown in FIGS. 13A-13C, the inner taper sleeve 295 has a conical shape with a split 298 along its length. As best shown in FIG. 13C, the outer surface 296 defines a plurality of ribs to grip against the pressure reinforcement layers (12; See FIG. 2A). The inner surface 296 defines a corresponding thread that mates with the nut's threaded surface (291) when the taper nut (290) tightens into the sleeve 295. When tightened, the split 298 allows the diameter of the sleeve 295 to expand and press the layers (12) against the inside conical surface of the insert (280) (See FIG. 2A).

Assembly Stage F

After inner sleeve 250, taper nut 290 and sleeve 295, and flanged end 240 are assembled as above, assemblers pull up the outer sleeve 275 against the outside of the flared layers 15. Once positioned, assemblers pull up and tighten the outer taper nut 270 onto the sleeve 275, compressing the sleeve 275 and layers 15 against the outside surface of the insert 280 through the applied toque. Again, the angle used and the compression applied can depend on the implementation.

As shown in FIGS. 9A-9C, the outer taper nut 270 has a conical inner surface 271 defining a left-handed thread for threading onto the taper sleeve (275). The nut 270 also has a cylindrical outer surface 272 that is smooth and fits against the inside wall of the shell 230. An end of the nut 270 defines a plurality of notches 273 to allow a tool to rotate and torque the nut 270 when threading it onto the sleeve (275).

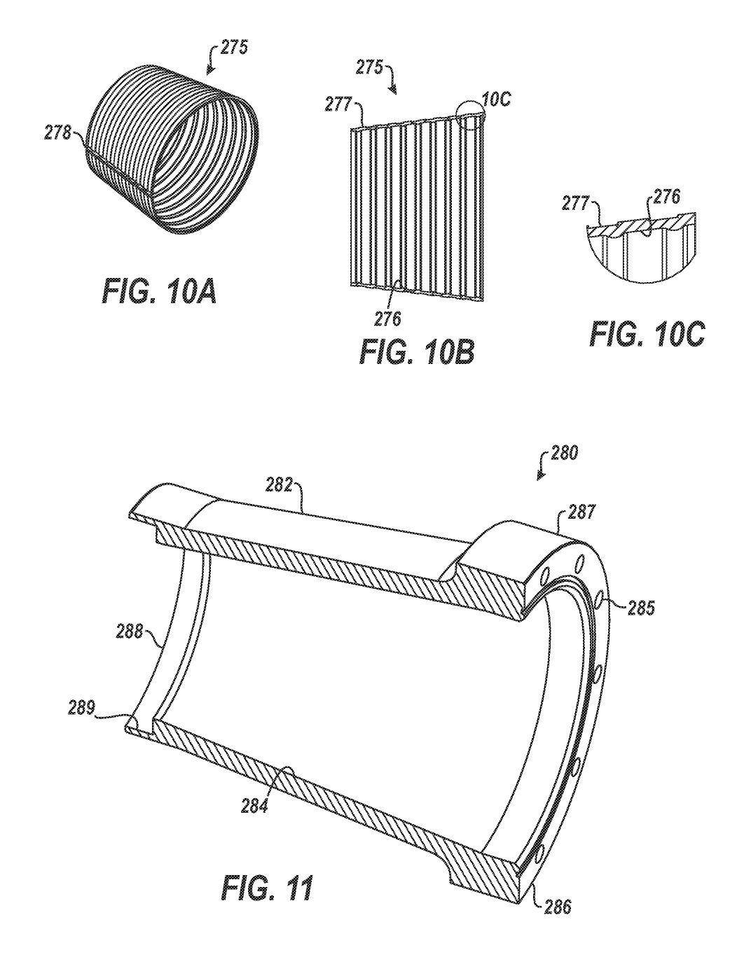

As shown in FIGS. 10A-10C, the outer taper sleeve 275 has a conical shape with a split 278 along its length. As best shown in FIG. 10C, the inner surface 276 defines a plurality of ribs to grip against the tensile reinforcement layers (15; See FIG. 2A). The outer surface 277 defines a corresponding thread that mates with the nut's threaded surface (271) when the taper nut (270) tightens onto the sleeve 275. When tightened, the split 278 allows the diameter of the sleeve 275 to compress and press the layers (15) against the outside conical surface of the insert (280) (See FIG. 2A).

Assembly Stage G

With the nuts 270/290 and sleeves 275/295 gripping layers 13/15 to the insert 280, assemblers pull up the shell 230 to the flanged end 240 and bolt them together using a second set of bolts 244. Then, assemblers torque all the bolts between flanged end 240, insert 280, and shell 230. If desired, the void 208 visible in FIG. 2B between the shell 230, nut 270, and insert 280 can be filled with epoxy when bringing the shell 230 up to the flanged end 240 or by using a filling port (not shown) in the shell 230 or in the flanged end 240. Although shown as separate components in the present embodiment, the shell 230 and the outer taper nut 270 may be combined to form an integral shell component that both bolts to the flanged end 240 and threads onto the taper sleeve 275. Keeping the shell 230 and nut 270 separate, however, allows the torque applied by the nut 270 to be better controlled during assembly.

As shown in FIGS. 6A-6C, the shell 230 has a first end 232 for bolting to the flanged end 240 and has a smaller end 234 for bolting to the adapter lock 220. The inner passage of the shell 230 has a wider portion 236A to accommodate the taper nuts (280/290), sleeves (285/295), and insert (280). First slots 238A receive O-rings (not shown) to engage the shelf 287 of the insert 280. Likewise, second slots 238B receive O-rings (not shown) to engage the pipe's external jacket 16.

To further hold the taper nut 270 positioned in the shell 230 as in FIG. 2A, assemblers insert a plurality of elongated pins 265 through the holes 233 in the shell 230. As shown in FIG. 6C, the holes 233 extend from the second end 232 to the shoulder defined between the two portions 236A-B within the shell 230. As best shown in FIG. 2B, ends of the inserted pins 235 fit against the end of the nut 270. Set screws and look screws 237 then thread into the holes 233 to lock the pins 235 in place.

Assembly Stage H

With the shell 230 in place, assemblers pull up the adapter lock 220 and bolt it to the shell 230. Finally, the stiffener sleeve 260 positions in place on the outside of the external jacket 16, and assemblers pull up and thread the stiffener body 210 onto the stiffener sleeve 260. As the body 210 is tightened, holes on its flanged end line up with those on the adapter 220, and assemblers then bolt the stiffener body 210 to the adapter lock 220.

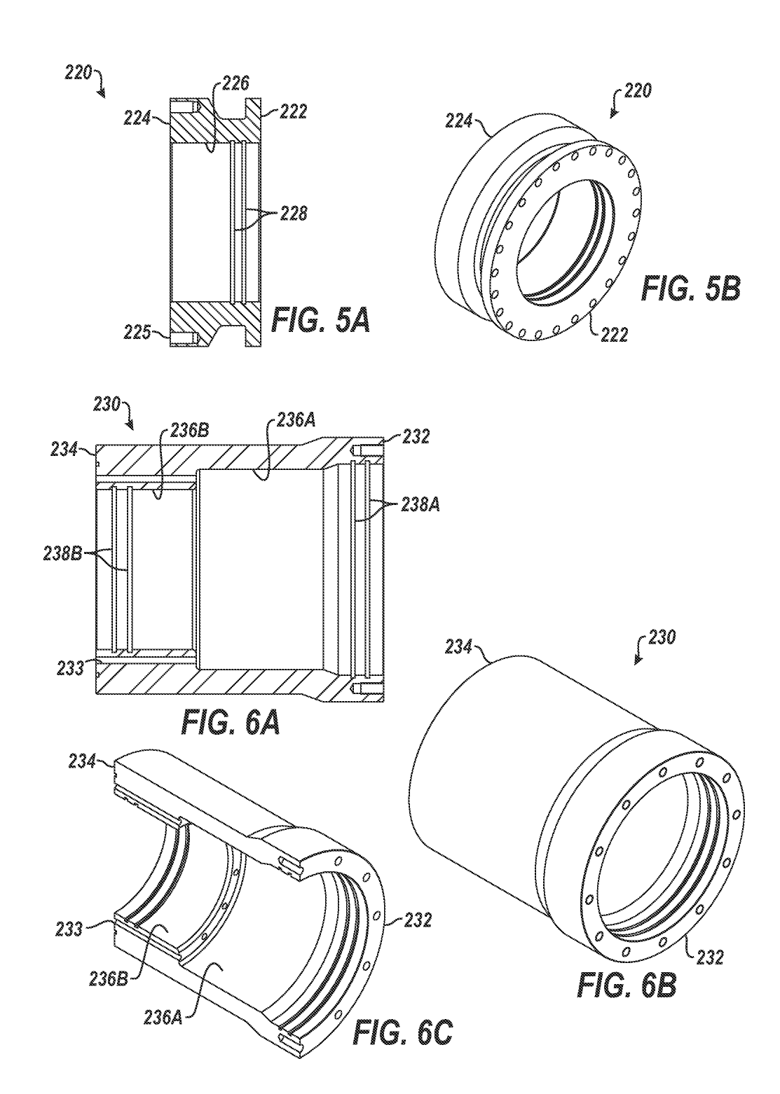

As shown in FIGS. 5A-5B, the adapter lock 220 has a first flanged end 222 and a second end 224 with bolt holes 225. In addition, the lock 220 has a cylindrical inner surface 226 with a plurality of grooves 228 for O-ring seals (not shown) to engage the pipe's external jacket 16. As shown in FIGS. 8A-8C, the stiffener sleeve 260 has a cylindrical inner surface 261 defining a set of grooves and has a conical outer surface 262 defining a thread complementary to the body's inner thread (See 218; FIG. 3A). In addition, the stiffener sleeve 260 defines a slit 263 along its length that allows the inner diameter of the sleeve 260 to decrease as it is tightened about the pipe 10.

As shown in FIGS. 3A-3C, the stiffener body 210 has a first end 212 defining a conical inner thread 218 (shown in detail in FIG. 3B) and has a second end 214 having an opening 213 from which the pipe extends. As shown in FIG. 3A, the opening 213 can be flared to help prevent crimping of the flexible pipe as it extends from the end 214. To thread the body 210 onto the sleeve 260, the outside of the body 210 defines indents 215 for a tool to engage the body 210 during turning. In one embodiment, the stiffener body 210 is elongated as in FIGS. 3A and 3C. For example, the stiffener body 210 can have an overall length of about 24-inches for a 6-inch internal diameter pipe 10 with about a 10-inch outside diameter. An alternative stiffener in FIG. 4 includes a body 210′ having the same first end 212 as that of FIG. 3C but having a shorter second end 214′. This stiffener body 210′ can have an overall length of about 12-inches for the same 6-inch internal diameter pipe 10.

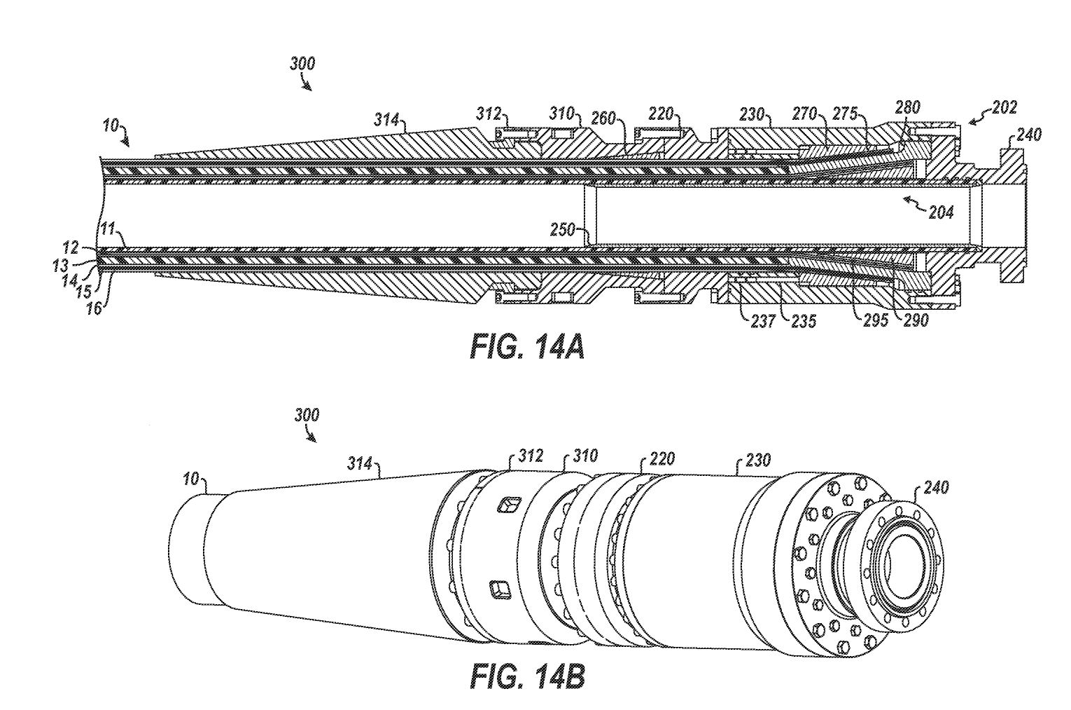

Referring to FIGS. 14A-14B, another end connector 300 has a number of similar components to the embodiment of FIGS. 2A-2B discussed above so that like reference numerals are used for similar components. This end connector 300 is a flowline assembly connector preferably used for a relatively longer span of flexible pipe 10 such as used in a flowline application or the like. In addition to the previously discussed components, the end connector 300 has a stiffener housing 310, a collar 312, and a flexible, elongated bend stiffener 314.

To assemble this variation, assemblers thread the stiffener housing 310 to the sleeve 260 and bolt it to the adapter lock 220 as before. Then, assemblers slide up the bend stiffener 314 into a distal end of the housing 310, place the two-part collar 312 around the end of the stiffener 314, and bolt the collar 312 to the face of the housing 310 to hold the bend stiffener 314 to the end connector 300. Whereas the stiffener (210 of FIG. 3A) can have an overall length of about 24-inches for a 6-inch internal diameter pipe 10 with about a 10-inch outside diameter, the bend stiffener 314 itself can be about 40-inches in length from the housing 310 for the same sized pipe. The bend stiffener 314 can be composed of a rubber, elastomer, or other flexible material. In this way, the housing 310, collar 312, and bend stiffener 314 can help prevent damage to the pipe 10 when moved by sea currents in the flowline application.

It will be appreciated that dimensions of the components can be adjusted for a particular implementation and size of flexible pipe. It will also be appreciated that the end connector's components can be composed of various materials depending on the implementation. For off-shore use, the outer housing components of the stiffener body 210, adapter lock 220, shell 230, flanged end 240, stiffener housing 310, and collar 312 are preferably composed of 4140 steel and can have their surfaces treated for corrosion resistance. The inner sleeve 250 is preferably composed of 316 stainless steel. In addition, the slopped insert 280 is preferably composed of 4140 steel. Preferably, the taper nuts 270, 290 are composed of 4140 steel, and the sleeves 260, 275, and 295 are composed of P550 stainless steel (specification Schoeller-Bleck), which is a high-nitrogen, nickel-free stainless steel (19 Cr, 0.5 Mo, 0.6N, 0.06 C) having a much higher yield strength than typical stainless steels.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A flexible pipe end connector, comprising:
an insert having inner and outer surface and positioning between at least first and second layers of the pipe;
an outer lock mechanically compressing at least one first layer of the flexible pipe against the outer surface of the insert;
an inner lock mechanically compressing at least one second layer of the flexible pipe against the inner surface of the insert; and
a housing positioning on the flexible pipe and enclosing the insert and the first and second locks.

2. The connector of claim 1, wherein the housing comprises an end body and at least one first body, the end body being flexible and positioning on the flexible pipe, the at least one first body being rigid and positioning on the flexible pipe adjacent the end and the end body, the end body coupling to the at least one first body.

3. The connector of claim 1, wherein the outer lock comprises an outer nut and an outer sleeve, the outer sleeve positioned between the outer nut and the at least one first layer, the outer nut threading onto the outer sleeve and compressing the outer sleeve and the at least one first layer against the outer surface of the insert.

4. The connector of claim 3, wherein the outer nut has an inner surface defining a thread, and wherein the outer sleeve has an outer surface defining a complimentary thread and has an inner surface defining a plurality of ribs.

5. The connector of claim 1, wherein the inner lock comprises an inner nut and an inner sleeve, the inner sleeve positioned between the inner nut and the at least one second layer, the inner nut threading into the inner sleeve and compressing the inner sleeve and the at least one second layer against the inner surface of the insert.

6. The connector of claim 5, wherein the inner nut has an outer surface defining a thread, and wherein the inner sleeve has an outer surface defining a plurality of ribs and has an inner surface defining a complimentary thread.

7. The connector of claim 1, further comprising a sleeve positioned between an inside of the housing and an outside of the flexible tube, the sleeve threading to the inside of the housing and pressing against the outside of the flexible pipe.

8. The connector of claim 7, wherein the housing comprises an end body and at least one first body, the end body having a thread complimentary to a thread on the sleeve, the end body positioning on the outside of the flexible pipe, the sleeve positioning on the outside of the flexible pipe, the end body threading onto the sleeve and bolting to the at least one first body.

9. The connector of claim 1, further comprising a cylindrical sleeve positioning within an inner bore of the flexible pipe.

10. The connector of claim 9, wherein the cylindrical sleeve has a length that is less than that of the housing.

11. The connector of claim 1, wherein the inner and outer surfaces of the insert are conical.

12. A flexible pipe end connector, comprising:
a housing positioning onto an end of a flexible pipe;
an insert positioned in the housing and having inner and outer surfaces;
an outer sleeve positioned in the housing against at least one first layer of the flexible pipe;
an outer nut positioned in the housing, the outer nut threading onto the outer sleeve and compressing the at least one first layer against the outer surface of the insert;
an inner sleeve positioned in the housing against at least one second layer; and
an inner nut positioned in the housing, the inner nut threading onto the inner sleeve and compressing the at least one second layer of the flexible pipe against the inner surface of the insert.

13. The connector of claim 12, wherein the housing comprises an end body and at least one first body, the end body being flexible and positioning on the flexible pipe, the at least one first body being rigid and positioning on the flexible pipe adjacent the end and the end body, the end body coupling to the at least one first body.

14. The connector of claim 12, wherein the outer nut has an inner surface defining a thread, and wherein the outer sleeve has an outer surface defining a complimentary thread and has an inner surface defining a plurality of ribs.

15. The connector of claim 12, wherein the inner nut has an outer surface defining a thread, and wherein the inner sleeve has an outer surface defining a plurality of ribs and has an inner surface defining a complimentary thread.

16. The connector of claim 12, further comprising a sleeve positioned between an inside of the housing and an outside of the flexible tube, the sleeve threading to the inside of the housing and pressing against the outside of the flexible pipe.

17. The connector of claim 16, wherein the housing comprises an end body and at least one first body, the end body having a thread complimentary to a thread on the sleeve, the end body positioning on the outside of the flexible pipe, the sleeve positioning on the outside of the flexible pipe, the end body threading onto the sleeve and bolting to the at least one first body.

18. The connector of claim 12, further comprising a cylindrical sleeve positioning within an inner bore of the flexible pipe.

19. The connector of claim 18, wherein the cylindrical sleeve has a length that is less than that of the housing.

20. The connector of claim 12, wherein the inner and outers surfaces of the insert are conical.

21. A flexible pipe end connector, comprising:
a housing fitting onto an end of a flexible pipe;
an insert positioning in the housing between first and second inner layers of the flexible pipe;
first means positioned between the housing and the first inner layer for compressing the first inner layer against the insert; and
second means positioned in the housing between the second inner layer and a third inner layer for compressing the second inner layer against the insert.

22. The connector of claim 21, wherein the housing comprises means for flexibly connecting an end of the housing to the flexible pipe.

23. The connector of claim 21, further comprising means for supporting an internal bore defined within the third inner layer.

24. The connector of claim 21, further comprising means positioned between an inside of the housing and an outside of the flexible tube for compressing against the outside of the flexible tube.

25. The connector of claim 21, wherein the first means comprises means for locking in the housing.
